(19) United States
(12) Patent Application Publication
(10) Pub. No.: US 2008/0141486 A1
(43) Pub. Date: Jun. 19, 2008

(54) Fire damper latching apparatus

(75) Inventor: Eldon Goates, Colorado Springs, CO (US)

Correspondence Address: McCulloch PLC, 1st Floor, 5291 Colony Drive North, Saginaw, MI, 48638, US

(73) Assignee: Globe Technologies Corporation

(21) Appl. No.: 11/640,606

(22) Filed: Dec. 18, 2006

(51) Int. Cl. E05F 15/20

(52) U.S. Cl. 16/48.5

(57) ABSTRACT

Latching apparatus for use with a fire damper assembly wherein extendable and retractable damper leaves normally are maintained by a fusible linkage in a position enabling air to flow through a duct. The fusible linkage may be coupled to and uncoupled from a damper-supporting frame so as to facilitate testing of the damper assembly to ensure it is capable of automatically moving from its passage-open position to a passage-closed position in response to a predetermined rise in ambient temperature. The latching mechanism is operable simply by squeezing a spring retainer to enable it to pass into and out of latched engagement with a latch keeper.

This invention relates to latching apparatus adapted for use in connection with a fire damper of the kind having leaves normally occupying a selected one of two positions, the latch apparatus being easily and quickly operable to enable the damper leaves to occupy either position.

### BACKGROUND OF THE INVENTION

It is common practice to equip buildings with ducts forming passages through which air may flow from a source to a plurality of areas into which such air may be discharged. It also is common practice to install in such air passages one or more dampers each of which normally occupies a position in which air is enabled to flow through the passage to an outlet. However, in the event of an increase of ambient temperature to a predetermined level it is desirable that the damper be movable automatically from a position in which air may flow through the passage to an adjusted position in which the flow of air through such passage is blocked.

In those instances in which ambient temperature has not increased to the predetermined level for an extended period of time it is necessary that the mechanism by means of which the damper is movable to its passage-blocking position be tested periodically to ensure its operability.

A typical air passage is relatively small in area and the location of a damper in such passage may be such that inspection of the apparatus is awkward or difficult. In those instances in which the damper leaves are supported by a fusible link which collapses when a predetermined temperature rise occurs, the inspection process is one wherein the intact fusible link is withdrawn manually from its damper-supporting condition, thereby making it possible to verify that the damper can move to a position in which air movement through the passage is blocked. Following the verification of the ability of the damper leaves to move automatically to their passage-closed position, the leaves may be returned manually to their passage-open position and the fusible link reset so as once again to support the leaves in their passage-open position. In those cases in which the damper assembly is difficult for an inspector to reach and manipulate, the resetting of the assembly in condition for automatic closing of the passage sometimes is unsatisfactory.

A principal object of the present invention is to provide latch apparatus for a damper assembly having a fusible linkage normally maintaining damper leaves in passage-open position and which is easily, quickly, and positively adjustable between damper supporting and damper disengaged positions even in those instances in which there is little space for a person's hands and/or in the event the latch apparatus is not in a position easily to be viewed.

### SUMMARY OF THE INVENTION

Latch apparatus constructed in accordance with the disclosed embodiments of the invention is adapted for use with a damper assembly mounted in an air duct or passage and having leaves biased to move from a passage-open position to a passage-closed position in response to a rise in ambient temperature to a predetermined level. The damper leaves may be biased by gravity or otherwise to move from their passage-open position to their passage-closed position.

The latch apparatus includes a pair of separable links maintained in assembled relation by a eutectic material which liquefies at a predetermined temperature, thereby enabling the links to separate or collapse. From opposite ends of the assembled links extend connectors which rockably couple the assembled links to manipulatable latch members having retainers which are capable of passing through openings in a keeper member so as to enable the links to be moved between positions in which the assembled links support damper leaves in passage-open position and another position in which the damper leaves are free to move to passage-closed position.

The retainer of each latch member is so configured as to pass through an opening in the latch keeper member and, once the latch member is in its latching condition, the retainer cooperates with the keeper to provide secure support for the fusible link assembly. However, manipulation of the latch member enables it manually to be withdrawn from the keeper thereby permitting the fusible link assembly to swing to a position in which the leaves of the damper automatically may move to a position in which they block movement of air through the passage.

The construction of the latch assembly is such that the retainer manually can be reassembled with the latch keeper following testing of the ability of the damper leaves to move from their passage-open position to their passage-closed condition. The construction of the retainer and the keeper is such that a person may disconnect the fusible link assembly from the keeper and recoupled the link assembly to the keeper without actually having to view the operative components and without the necessity of structurally deforming or otherwise modifying, even temporarily, any component of the latching assembly. As a consequence, the operation of the latch retainer in its uncoupling from and recoupling to the keeper is simple and easily and quickly accomplished so as to facilitate greatly the operations. As a consequence, the inspection and resetting of the damper apparatus are more likely to be accomplished properly than hitherto has been the case.

### THE DRAWINGS

FIG. 1 is an isometric view illustrating a damper having leaves supported in a retracted, air passage-open condition by a fusible supporting link assembly;

FIG. 2 is an isometric view of the fusible link assembly and the latching mechanism associated therewith, but omitting the damper and associated structure for purposes of clarity;

FIG. 3 is a fragmentary, isometric view illustrating one end of a fusible link assembly latched in damper-supporting condition;

FIG. 4 is a sectional view on the line A-A of FIG. 3;

FIG. 5 is a fragmentary, isometric view of a modification; and

FIG. 6 is a fragmentary, isometric view of a component modified to cooperate with the construction shown in FIG. 5.

### THE PREFERRED EMBODIMENTS

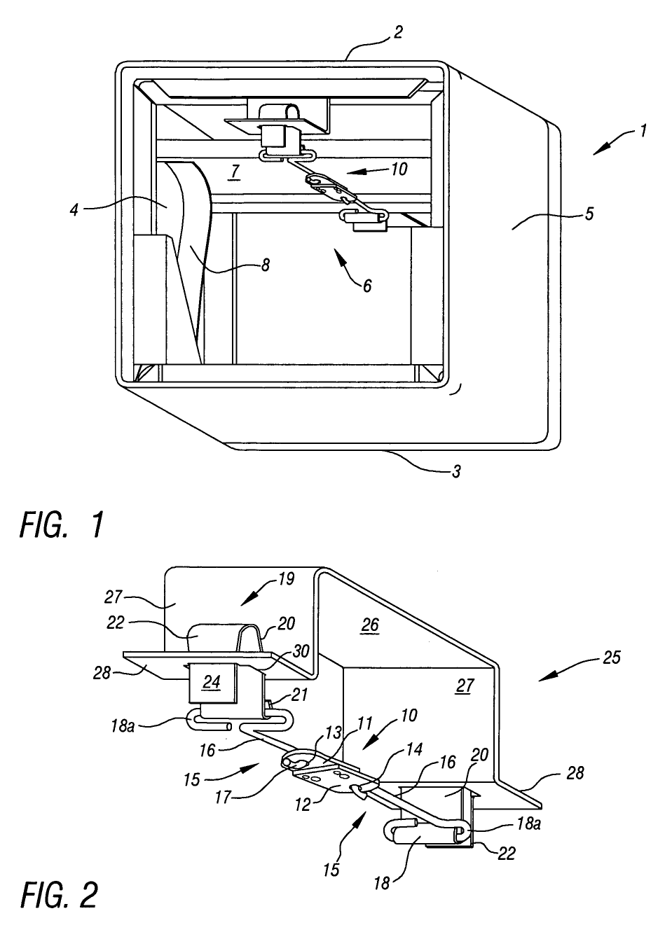

Apparatus constructed in accordance with the embodiment of the invention disclosed in FIGS. 1-4 is adapted for installation in a frame 1 having top and bottom walls 2 and 3, respectively, and opposed side walls 4 and 5. The frame 1 is of such size as to be accommodated in a conventional duct (not shown) forming a passage (of which the frame is a part) through which air may flow from a source (not shown) to one or more outlets (not shown) through which air may be discharged to one or more areas within a building.

Within the frame 1 is a damper assembly 6 comprising a plurality of leaves 7 pivotally coupled to one another in known manner. The uppermost leaf is secured to the inner surface of the top wall 2 and the leaves 7 are so arranged that they may move from retracted or nested passage-open condition, as shown in FIG. 1, to a passage-closed condition in which the leaves together form a partition extending between the top and bottom walls of the frame so as to block the flow of air through the passage in which the damper assembly is installed. The damper leaves are so constructed that their movement from their retracted condition to their extended condition may occur by gravity. However, it is preferred to provide a biasing spring arm 8 having one end secured to the lowermost leaf 7 and its opposite end secured to an automatic winding mechanism, as is conventional. The damper assembly corresponds to that disclosed in co-pending application Ser. No. 11/518,835, filed Sep. 11, 2006, the disclosure of which is incorporated herein by reference.

In some cases it may be possible to avoid use of the frame 1, except for a keeper which is yet to be described. In such cases the walls of an air duct corresponding to the walls of the frame 1 may be used.

A fusible linkage assembly 10 of known construction is provided for the purpose of maintaining the damper leaves in their retracted or air passage-open position until such time as ambient temperature rises to a predetermined level. The assembly 10 comprises a pair of links 11 and 12 which partially overlap one another and are bonded together at the overlap by a eutectic material (not shown) which liquefies at a predetermined elevated temperature and enables the links to separate from one another. Such fusible link assemblies are well known in the art.

The link 11 has an opening 13 at its free end and the link 12 has a similar opening 14 at its free end. Associated with the links 11 and 12 is a pair of connectors 15 each of which has a stem 16 terminating at one end in a hook 17 which passes through the associated opening 13 or 14. The stem terminates at its other end in a loop 18. Each loop forms a coupling 18 for a latch member 19, each of which comprises a resilient metal retainer strap section 20 terminating at one end in a reversely turned flange 21 in which is accommodated the associated loop 18a. The strap section 20 is reversely turned between its opposite ends to form a nose from which a second strap section 22 extends. The two strap sections 20 and 22 diverge from the nose end and confront and are spaced from each other.

The strap section 22 terminates at its free end in a projecting tongue 24. As is best shown in FIG. 4, the tongue 24 has a width less than that of the section 22 so as to form a pair of movement limiting shoulders 23 at the juncture of the parts 22 and 24.

The apparatus includes a latch keeper member 25 comprising a generally U-shaped frame having a top wall 26 and a pair of spaced, parallel side walls 27 each of which terminates in a laterally extending flange 28. The top wall 26 and/or the side walls 27 are welded or otherwise secured to the corresponding walls of the frame 1 so as to form an integral part of the latter.

Each of the flanges 28 of the keeper has a rectangular opening 30 having an area sufficient to accommodate freely the strap sections 20 and 22. The opening 30 is provided with a contiguous outboard notch 31 having an area less than that of the opening 30 and a length less than the width of the strap section 22. However, the length of the notch is sufficient to enable the tongue 24 freely to pass therethrough, as is best shown in FIG. 4.

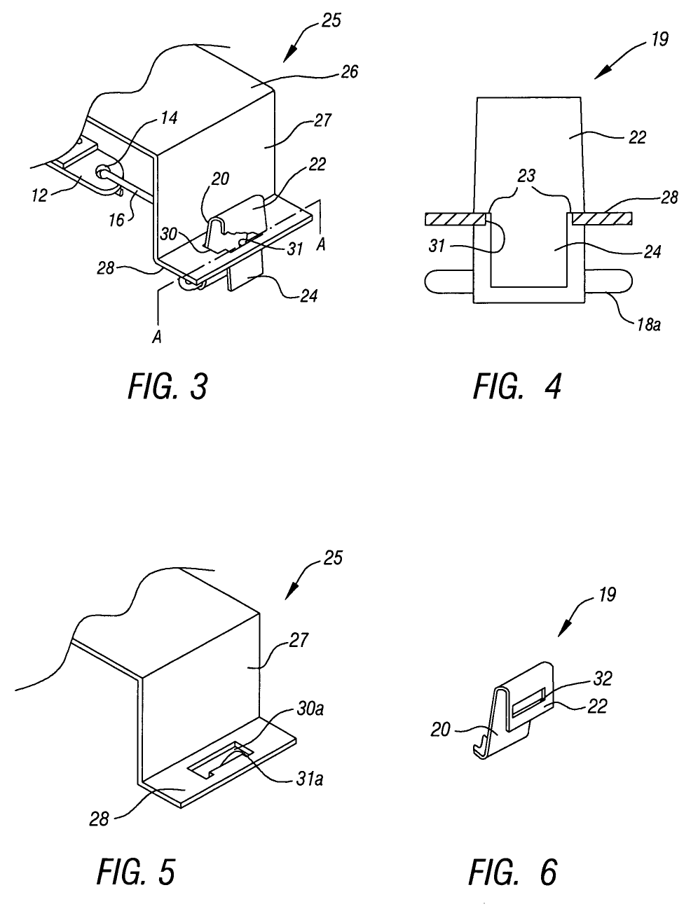

Although the tongue 24 is illustrated as being narrower than the section 20, the arrangement could be reversed so that the section 20 is wider than the tongue. In this arrangement the latch member 19 would be rotated through 180° from the position shown in FIGS. 3 and 4 so that the narrow strap section 20 passes through the notch 31 and the wider section 22 passes through the opening 30. The shoulders 23 would be formed on the strap section 20.

The construction and arrangement of the latch retainer and the keeper are such that, when the strap section 22 is displaced toward the strap section 20, the latch retainer may pass through the opening 30, nose first, following which the resiliency of the metal from which the tongue 24 is formed will cause the tongue to enter and occupy the notch 31. The shoulders 23 will rest atop the flange 28 adjacent the notch so as to prevent further movement of the latch retainer through the opening 30 unless the tongue 24 is displaced by squeezing it toward the strap section 20.

The apparatus normally occupies the positions shown in FIG. 1 wherein the damper leaves 7 are in their elevated, retracted condition so as to enable air to flow through the duct in which the damper assembly is mounted. The fusible link assembly 15 underlies the damper leaves and is maintained in its damper-supporting position by means of the latch retainers 19 occupying the respective openings 30 in the keeper flanges 28.

In the event the ambient temperature rises to the predetermined level at which the eutectic material liquefies, the links 11 and 12 will separate, thereby enabling the individual links and their connectors 16 to swing downwardly by gravity and remove the support for the damper leaves. The leaves then will move downwardly, either by gravity or under the influence of the spring arm 8, so that the extended damper leaves will form a partition blocking the passage of air through the duct.

When it is required to test the ability of the damper to move automatically from its passage-open position to its passage-closed position, either one of the latch retainers 19 may be adjusted manually by moving the tongue 24 toward the opposing part of the strap section 20, thereby shifting the shoulders 23 to a position in which the entire latch retainer may pass downwardly through the opening 30 in the flange 28 and be withdrawn from the keeper member 25. This will enable the assembled linkage 10, along with the connectors 16 and the latch retainer which has been removed from its associated keeper flange 28, to swing downwardly and withdraw the support for the damper. The damper leaves then are free to move to their extended condition in which the passage of air through the duct is blocked. In the event the damper leaves do not move automatically to the passage-closed position, remedial servicing may be performed.

Following testing of the operability of the damper assembly, the leaves 7 may be returned manually to their retracted positions, the fusible linkage assembly 10 may be swung to a position in which it underlies the damper leaves, the retainer strap section 22 may be displaced toward the opposed strap section 20, and the latch retainer thrust upwardly through the opening 30. When the latch retainer has moved through the opening an appropriate distance, the tongue 24 may be released whereupon the resilience of the material from which the latch retainer is formed will enable the tongue 24 to move into the notch 31, whereupon the shoulders 23 will rest atop the flange 28 and maintain the fusible link assembly 15 in its damper-supporting position.

A damper inspector will be able to effect unlatching and latching of the fusible link assembly relative to the keeper without actually having to view the assembly. Further, apart from squeezing the confronting portions of the latch toward one another to remove the latch retainer from the keeper, no adjustment or dismantling of any part of the apparatus is required. Accordingly, the uncoupling and recoupling of the fusible link assembly with the damper apparatus may be easily and quickly accomplished.

FIGS. 5 and 6 illustrate a modified embodiment in which each of the flanges 28 of the keeper 25 has an opening 30a, but instead of including a notch like the notch 31, there is a lip 31a at the center of the opening 30a and an opening 32 in the strap section 22 of such size as to accommodate the lip 31a when the nose of the latch retainer is pushed through the opening 30a a distance sufficient to enable the opening 32 to receive the lip 31a. In operating respects all of the disclosed embodiments are virtually the same.

The disclosed embodiment is representative of a presently preferred form of the invention, but is intended to be illustrative rather than definitive thereof. The invention is defined in the claims.

I claim:

1. Latching apparatus comprising a latch member and a keeper member having an opening therein for the accommodation of said latch member, said latch member comprising a resilient strap having opposite ends, said strap being reversely bent between said ends to form two spaced apart, confronting sections, both of said sections being of such dimensions as to extend through said opening, one of said sections having coupling means for connection to an object, the other of said sections having movement limiting means cooperable with said keeper member for limiting movement in one direction of said sections through said opening.

2. The apparatus according to claim 1 wherein said limiting means comprises at least one shoulder on one of said sections overlying and engaging said keeper adjacent said opening.

3. The apparatus according to claim 1 wherein said sections of said strap are resiliently movable toward and away from one another so as to vary the space therebetween.

4. The apparatus according to claim 1 wherein said opening has a first relatively large area and a contiguous relatively small area, both sections of said strap being movable through said first relatively large area of said opening, but only one of said strap sections being movable through said second relatively small area of said opening.

5. The apparatus according to claim 1 wherein said relatively small area of said opening comprises a notch in communication with said large area.

6. The apparatus according to claim 1 including a lip extending into said opening.

7. The apparatus according to claim 6 wherein one of said strap sections has an opening therein for removably accommodating said lip.

8. The apparatus according to claim 4 wherein said coupling means comprises a hook for accommodating a portion of said object.

9. The apparatus according to claim 8 wherein said object comprises a linkage having at one end thereof a connector, said connector constituting said portion of said object.

10. Apparatus for latching a fire damper in a first position in which air in a passage may move past said damper, said damper being movable to a second position in which movement of air through said passage is blocked, said apparatus comprising a fusible linkage assembly having a pair of links normally secured to each other by a eutectic material which liquefies in response to an increase in ambient temperature to a predetermined level, at least one latch retainer, attaching means connecting said linkage assembly to said latch retainer in a position to enable said linkage assembly to support said damper in said first position; and keeper means, said linkage assembly, said latch retainer, and said keeper means being operable to maintain said damper in said first position, said latch retainer comprising a strap formed of resilient material bent to form two spaced apart confronting sections one of which is connected to said attaching means and both of which are releasably supported by said keeper.

11. The apparatus according to claim 10 wherein said latch retainer comprises a resilient strap having spaced apart, confronting sections movable toward and away from one another, said keeper means having therein an opening in which said latch retainer removably may be accommodated.

12. Apparatus according to claim 11 wherein said opening is in communication with a notch having a width less than that of one of said sections, said one of said sections being of such width as to be accommodated in said notch.

13. The apparatus according to claim 9 wherein said one of said sections has shoulders projecting laterally beyond opposite sides of said extension.
